(19) United States
(12) Patent Application Publication
(10) Pub. No.: US 2016/0224968 A1
(43) Pub. Date: Aug. 4, 2016

(54) METHODS OF SUPPLYING CAPITAL TO PREPAID CARD ISSUERS AND ESTABLISHING INCOME STREAMS FOR HOLDERS OF PREPAID CARDS

(71) Applicant: Monadhl Assad A. Hakeem, Jeddah (SA)

(72) Inventor: Monadhl Assad A. Hakeem, Jeddah (SA)

(21) Appl. No.: 14/827,438

(22) Filed: Aug. 17, 2015

Related U.S. Application Data
(60) Provisional application No. 62/038,238, filed on Aug. 16, 2014.

(51) Int. Cl. G06Q 20/28; G06Q 20/34

(52) U.S. Cl. CPC G06Q 20/28; G06Q 20/3433; G06Q 20/349

(57) ABSTRACT

A method includes a card issuer providing a prepaid card set to a cash value and a purchase price that is less than the cash value, a customer obtaining an installment loan from a lender for an amount equal to the purchase price of the prepaid card and that is repayable to the lender by periodic repayments, the lender paying the amount to the card issuer, the card issuer issuing the prepaid card to the customer and designating the customer an authorized user of the prepaid card, when the card issuer receives the amount from the lender, the card issuer loading the cash value to the prepaid card by periodic loads taken from the amount, and the authorized user repaying the installment loan to the lender by the periodic repayments. The total of the repayments is greater than the purchase price, and is less than the cash value.

### CROSS-REFERENCE TO RELATED APPLICATION

This application claims the benefit of U.S. Provisional Patent Application Ser. No. 62/038,238, filed Aug. 16, 2014, the entire contents of which are incorporated herein by reference.

### FIELD OF THE INVENTION

The present invention relates to prepaid cards, to methods of supplying issuers of prepaid cards with capital, to methods of issuing prepaid cards, and to methods of establishing streams of income for authorized users of prepaid cards.

### BACKGROUND OF THE INVENTION

Credit cards are devices most commonly represented by a plastic card-like member through the use of which an authorized user pays for, by way of example, services and/or merchandise and the like. Credit cards are universally well known and ubiquitous, and have fundamentally changed the way financial transactions and dealings are viewed and conducted in society today. Credit cards issued by a bank provide a mechanism by which a user purchases goods without an immediate, direct exchange of cash and thereby incurs debt which the user may thereafter, upon receipt of a monthly or otherwise periodic statement, either pay the outstanding balance or, as a matter of choice, defer the balance for later payment with accompanying interest or finance charges for the period during which payment of the debt is deferred.

Increasingly, credit cards are being issued by banks in association with other organizations/enterprises that offer or sell goods and/or services. This phenomenon, known as co-branding, provides a credit card that typically carries the name of a commercial company, with the commercial company or co-branding “partner” bringing to the cardholder of user added benefits which, not incidentally, assist the partner in the sale of its goods or services to the card user. Well known and successful examples of such co-branded cards include the General Motors MasterCard credit card—offering users up to a five-percent rebate on user-purchased General Motors automobiles, based on the volume of charges placed on the user's card—and airline-partnered credit cards which award the card user frequent flyer mileage on the basis of user-accrued card charges.

Current co-branded credit cards, although successful, may nevertheless lack additional actual or perceived advantages, to the user and/or to the issuer and/or commercial partner, which may perhaps otherwise be available or attainable. For example, the rapid proliferation of co-branded cards offering seemingly ever-increasing amounts or levels of user-earned “benefits” encourages individual users or subscribers to obtain multiple credit cards, by which users often correspondingly split or divide their purchases and transactions—previously charged on a single card—between a number of cards, thereby decreasing the transaction volume of each card at the expense of one or more others. Moreover, permitting users to earn awards based on purchases encourages users to incur increasing amounts of debt, at times exceeding the amount that a user is reasonably capable of repaying in a timely manner, increasing the possibility of user default with consequent damage to the bank, to the commercial partner, and/or to the organization whose goods or services were charged in the user's transactions with the card.

Without a good credit history, it can be difficult to obtain a credit card, and to obtain vehicle loans and mortgage loans. A credit card is usually required to make hotel and plane reservations, and to rent a car. Many stores require a credit card to accept a personal check. Responsible use of a credit card builds a good credit history and rating. But people who have never had credit or need to repair a poor credit history may not qualify for a regular credit card. For them, a secured credit card is the only way to establish, or re-establish, credit.

A secured credit card is a credit card established by depositing money into an account. The account serves as security for the card; if the bill isn't paid, the money in the account may be used to cover the debt. For example, if a user places $500 in the account, she can charge up to $500. More can be added to the deposit to add more credit, and sometimes a bank will reward a good payment history and add to the user's credit line without requesting additional deposits.

The amount a user is required to deposit for a secured credit card can vary. A typical minimum deposit is $300 to $500, but there are service providers that have lower minimum deposit requirements. The credit limit for a secured credit card is either the amount of the deposit or a percentage above the deposit amount.

A secured credit card can be a valuable stepping stone for individuals trying to establish, or re-establish, credit. The interest rates and fees on secured credit cards tend to be lower than those charged on unsecured credit cards targeted toward people with poor or no credit. Even so, secured credit cards are hardly bargains. Interest rates in the high teens and higher are typical, and so are annual fees. Because annual fees vary dramatically from offer to offer, it is advisable to shop around for the best possible offer. Also, not everyone can obtain a secured credit card. Card companies have different requirements for applicants. Some credit card companies will accept people who have had a bankruptcy as recently as six months to one year before they apply. However, most require that a court has discharged the bankruptcy. And still others will not consider people with a past bankruptcy.

A prepaid card is not a credit card since no credit is offered by the card issuer. In a prepaid card, the cardholder spends money which has been “stored” or “loaded” to an account associated with the prepaid via a prior deposit by the cardholder or someone else, such as a parent or employer. A prepaid card can be used in similar ways just as though it were a credit card or a debit card. After purchasing the prepaid card, the cardholder loads the account with any amount of money, up to a predetermined card limit, and then uses the card to make purchases the same way as a typical credit or debit card. Prepaid cards can be issued to minors since there is no credit line involved. In fact, prepaid credit cards are often marketed to teenagers for shopping online without having their parents complete the transaction. Teenagers can only use funds that are available on the card which helps promote financial to reduce the risk of debt problems later in life. Prepaid cards can be used globally. The prepaid card is convenient for payees in developing countries like Brazil, Russia, India and China, where international wire transfers and bank checks are time consuming, complicated and costly. Because of the many fees that apply to obtaining and using prepaid cards, prepaid cards are widely considered to be an expensive way to spend your own money.

Prepaid cards are useful for people who have no credit or poor credit, and for people who want the purchasing power of a credit card without incurring debt. With prepaid cards purchasers are not charged any interest but are often charged a purchasing fee plus monthly fees after an arbitrary time period. Other fees often apply to prepaid cards. Although prepaid cards can be useful, the costs of prepaid cards paid by the cardholders are widely believed to be unreasonable and predatory.

A prepaid debit card enables the holder to make purchases and have them deducted from the prepaid card's available account balance. A prepaid card may be branded with a major credit card issuer's logo, such as American Express, VISA, or MasterCard, which enables the holder to make purchases wherever those cards are accepted. Other types of prepaid cards, such as department store gift cards, can only be used to make purchases at the business that issued the card. While prepaid cards may be convenient for the cardholder, the real benefit belongs to the card issuer. Because the cards are prepaid, the issuer gets immediate use of all the money that was used to fund the card, even if the cardholder takes months to spend it all. Most prepaid card issuers also charge an activation fee, and some charge a monthly fee while others may charge a “non-usage” fee if the card goes unused for a specific periodic of time after it was issued. Given the high cost of prepaid cards to cardholders and the low amounts of money cardholders allocate to fund prepaid cards, the need for improvement in the field of prepaid cards is evident.

### SUMMARY OF THE INVENTION

According to the principle of the invention, a method includes a card issuer providing a prepaid card set to a cash value, loadable to the prepaid card by periodic loads, and a purchase price that is less than the cash value, a customer obtaining an installment loan from a lender for an amount equal to the purchase price of the prepaid card and that is repayable to the lender by periodic repayments, the lender paying the amount to the card issuer, the card issuer issuing the prepaid card to the customer and designating the customer an authorized user of the prepaid card, when the card issuer receives the amount from the lender, the card issuer loading the cash value to the prepaid card by the periodic loads, and the authorized user repaying the installment loan to the lender by the periodic repayments, wherein a total amount of the repayments is greater than the purchase price of the prepaid card, and is less than the cash value of the prepaid card. Each of the periodic loads is greater than each of the periodic repayments. In illustrative embodiments, the periodic loads are equal, and the periodic repayments are equal.

According to the principle of the invention, a method includes a card issuer providing a prepaid card set to a cash value, loadable to the prepaid card by periodic loads, and a purchase price that is less than the cash value, a customer, having debt less than the cash value of the card, obtaining an installment loan from a lender for an amount equal to the purchase price of the prepaid card and that is repayable to the lender by periodic repayments, the lender paying off the debt with a portion of amount leaving a balance of the amount, and loaning the balance of the amount to the card issuer, the card issuer issuing the prepaid card to the customer and designating the customer an authorized user of the prepaid card, when the card issuer receives the balance of the amount from the lender, the card issuer loading the cash value to the prepaid card by the periodic loads, and the authorized user repaying the installment loan to the lender by the periodic repayments, wherein a total of the repayments is greater than the purchase price of the prepaid card, and is less than the cash value of the prepaid card. Each of the periodic loads is greater than each of the periodic repayments. In illustrative embodiments, the periodic loads are equal, and the periodic repayments are equal.

According to the principle of the invention, a method includes a card issuer providing a prepaid card set to a cash value, loadable to the prepaid card by periodic loads, and a purchase price that is less than the cash value, a customer, having debt less than the cash value of the card, obtaining an installment loan from a lender for an amount equal to the purchase price of the prepaid card and that is repayable to the lender by periodic repayments, the lender paying the amount to the card issuer, the card issuer paying off the debt, issuing the prepaid card to the customer, and designating the customer an authorized user of the prepaid card, when the card issuer receives the amount from the lender, the card issuer loading the cash value to the prepaid card by the periodic loads, and the authorized user repaying the installment loan to the lender by the periodic repayments, wherein a total of the repayments is greater than the purchase price of the prepaid card, and is less than the cash value of the prepaid card. Each of the periodic loads is greater than each of the periodic repayments. In illustrative embodiments, the periodic loads are equal, and the periodic repayments are equal.

### DETAILED DESCRIPTION

The present invention concerns, among other things, methods for funding a card issuer of prepaid cards with capital useful by the card issuer for producing wealth for the card issuer and for funding a prepaid card, issuing a prepaid card, and for establishing a stream of income for an authorized user of a prepaid card issued by the card issuer. In a prepaid card, money is “stored” or “loaded” to an account associated with the prepaid card. The prepaid card, an embossed plastic card bearing the name and account details of a financial institution and cardholder, used with a personal identification number (PIN) to make payments and purchases, is issued from a card issuer to an authorized user, i.e. the cardholder, of the prepaid card. The authorized user spends the money that has been stored or loaded onto the prepaid card, i.e. into the account associated with the prepaid card, via a prior deposit. The prepaid card is used to make purchases and to make payments the same way as a typical debit card. And so a prepaid card is one in which a load, i.e. money, applied, i.e. loaded, to the prepaid card, i.e. an account associated with the prepaid card, is drawn against when the prepaid card is used. Because a debit card is one in which money is taken from an existing funded account of an authorized user, such as a checking account, a savings account, etc., when the debit card is used, a debit card is considered a prepaid or “funded” card.

As used herein, the term “authorized user” is a person named on or to a prepaid card. Because a corporation and other legally established entities are often referred to as legal persons or entities, such organizations are included with the scope of “authorized user.” As used herein, the term “customer” is a person. Because a corporation and other legally established entities are often referred to as legal persons or entities, such organizations are included with the scope of “customer.” As used herein, the terms “lender” and “card issuer” are each a financial institution or bank including one or more or any and all participants of the invention including one or more or any and all partners thereof, subsidiaries thereof, agents thereof, intermediates thereof, corporations thereof, legal entities thereof, benefactors thereof, investors thereof, third parties thereof, etc. In sum, any party participating in or otherwise facilitating the implementation of the invention as or on behalf or in conjunction and/or cooperation with the lender or card issuer is subsumed, for the purpose of this disclosure, under each of the terms “lender” and “card issuer.”

According to the principle of the invention, an illustrative method includes a card issuer providing a prepaid card that is set to a cash value that is loadable to the prepaid card by periodic loads, and that is available for purchase at a designated purchase price. The purchase price of the prepaid card is less than the cash value of the prepaid card, which provides incentive for a customer to purchase the prepaid card for the discounted purchase price relative to the cash value of the prepaid card. According to the principle of the invention, the method next includes a customer designated to purchase the prepaid card obtaining an installment loan from a lender for an amount that is equal to the purchase price of the prepaid card and that is repayable to the lender by periodic repayments from the customer, the lender paying the amount to the card issuer and not to the customer, and the card issuer issuing the prepaid card to the customer and designating the customer an authorized user of the prepaid card, when the card issuer receives the amount from the lender. The customer and the authorized user are the same person according to the various embodiments described in detail throughout this disclosure. The method then includes the card issuer loading the cash value to the prepaid card by the periodic loads, and the authorized user repaying the installment loan to the lender by the periodic repayments, wherein a total amount of the repayments is greater than the purchase price of the prepaid card, and is less than the cash value of the prepaid card. In an illustrative embodiment, each of the periodic loads is less than each of the periodic repayments. In other embodiments, the periodic loads are equal, and the periodic repayments are equal.

The lender and the card issuer and the customer are different from one another, i.e. are different parties. The authorized user, the lender, and the card issuer are participating members of the method. The cash value of the prepaid card is set by the card issuer. The purchase price of the prepaid card is set by the card issuer. In an illustrative embodiment, the cash value and purchase price of the prepaid card is preselected by the card issuer in advance. In alternate embodiments, the cash value and purchase price of the prepaid card can be negotiated between the customer, the lender, and the card issuer, or can be determined based on the financial qualifications of the customer. The prepaid card bears the names and contact information of the lender and the card issuer. The prepaid card is offered for sale by the card issuer in an illustrative embodiment, and by the lender in another embodiment.

According to the invention, purchasing the prepaid card involves the customer obtaining the installment loan from the lender for an amount, i.e. the “loaned amount,” that is equal to the purchase price of the prepaid card and that is repayable to the lender by period repayments from the customer, all in accordance with the loan terms of the installment loan. The loan terms are set forth in an installment loan agreement, which is a written document that is, in accordance with the principle of the invention, duly and properly executed by the authorized user, an authorized party of the lender, and an authorized party of the card issuer. As the term suggests, the “loan terms” set for the mutually agreed-upon terms of the installment loan including, among other potential things typically included in an installment loan agreement, the amount of the installment loan that is equal price of the prepaid card, the term of the installment loan or loan period of time, the repayment schedule including when the periodic repayments are to be made and the amount of each repayment, how the periodic repayments are to be made, any applicable fees that may apply in the event of a late payment, the amount of the cash value of the prepaid card, the term of the load period of time, which is preferably equal to the loan period of time, the load schedule including when the periodic loads are to be made and the amount of each load, etc. In a particular embodiment, the installment loan is an unsecured loan. In another embodiment, the installment loan is a secured loan, which is collateralized by the authorized user's vehicle, motorcycle, house, or other collateral of the authorized user.

After the installment loan is finalized or otherwise secured, the method includes the lender paying the loaned amount, i.e. the loaned purchase price of the prepaid card, not to the customer but rather to the card issuer according to the loan terms, such as by check, wire transfer, or other payment method, and the card issuer issuing the prepaid card to the customer and designating the customer the authorized user of the prepaid card authorized user according to the loan terms, when the card issuer receives the amount from the lender. The card issuer issues the prepaid card to the customer and designates the customer as an authorized user of the prepaid card all according to well-established card-issuing methods employed by card issuers in the issuance of cash and debit/prepaid cards, the details of which are well known in the art. After the prepaid card is issued to the authorized user, the method includes the card issuer loading the cash value to the prepaid card by the periodic loads, and the authorized user repaying the installment loan to the lender by the periodic repayments, all in accordance with the loan terms of the installment loan. According to the invention, the total amount of the repayments is greater than the purchase price of the prepaid card, and is less than the cash value of the prepaid card.

The method described above according to an illustrative embodiment involves the prepaid card, the lender (bank, financial institution), a card issuer (bank, financial institution), and the customer designated as the cardholder or authorized user. Preferably, a PIN number is encrypted or encoded on the prepaid card, and only the correct PIN number will provide access and validation for transactions using the prepaid card. An identification code or account number encoded on a separate security card is tied to the PIN number. If there is a loss or theft of the prepaid card, any existing balance in the account associated with the prepaid card will be reimbursed by presenting the security card to the card issuer or the lender.

The card issuer sets the cash value to the prepaid card, sets the purchase price for the prepaid card that is less than the cash value of the prepaid card, sets the loan period of time, sets the load period of time, sets the installment repayment schedule and the amount of each repayment, and sets the load payment schedule and the amount of each load payment. These details can be set by the card issuer via negotiations between the customer, the lender, and the card issuer. To acquire the prepaid card, the customer obtains the installment loan from the lender for the purchase price of the prepaid card, the amount equal to less than the cash value of the prepaid card, such as 80% of the cash value of the prepaid card, 75% of the cash value of the prepaid card, 70% of the cash value of the prepaid card, 65% of the cash value of the prepaid card, 60% of the cash value of the prepaid card, 55% of the cash value of the prepaid card, 50% of the cash value of the prepaid card, or other selected “discounted” purchase price amount relative to the cash value of the prepaid card. The purchase price of the prepaid card, i.e. the installment loan amount, is agreed upon between the lender and the card issuer in the installment loan agreement and also by the customer designated to purchase the prepaid card. In a particular embodiment, the installment loan is secured by the lender, in which the authorized user pledges some asset as collateral (e.g., car, home) for the installment loan, which then becomes a secured debt owed to the lender that gives the installment loan. The debt is not paid back by the card issuer, but by the authorized user of the prepaid card, i.e. the cardholder. In the event that the authorized user defaults, the lender takes possession of the asset used as collateral and may sell it to regain some of or the entire amount originally loaned to the card issuer. In an alternate embodiment, the installment loan is unsecured and not connected to any specific piece of property and instead the lender may only satisfy the debt against the authorized user rather than the authorized user's collateral.

After the installment loan is approved, the lender does not pay the customer the loaned amount equal to the purchase price of the card. Rather, the lender pays the card issuer the loaned amount, and the card issuer, in turn, issues the prepaid card to the customer and designates the customer an authorized user of the prepaid card. According to the loan terms of the installment loan in a particular example, the card issuer automatically electronically loads the prepaid card with periodic installment loads for the term of the prepaid card until the cash value of the prepaid card is reached. Each periodic installment load is a fraction of the purchase price of the prepaid card, i.e., the loaned amount received by the card issuer from the lender. The card issuer gets immediate use of the entire loaned amount that is used to fund the prepaid card, when the card issuer is paid the loaned amount from the lender. The periodic electronic loading is performed by the card issuers' pre-programmed electronic card-loading computer system linked to the account associated with the prepaid card. The authorized user, in turn, pays periodic installment repayments to the lender for the term of the prepaid card in payment of the installment loan obtained by the authorized user of the prepaid card. The installment loads made the by card issuer are equal amounts loaded periodically onto the prepaid card throughout the term of the prepaid card, also the term of the installment loan between the authorized user and the lender, and the installment repayments made by the authorized user are equal amounts paid periodically by the authorized user for the term of the prepaid card, again, the term of the installment loan between the authorized user and the lender. The installment loads can vary in amount or be unequal amounts, and the installment repayments can vary in amount or be unequal amounts, in alternate embodiments. Each installment repayment is made by the authorized user via cash, check, direct debit or direct withdrawal in which the lender withdraws funds from a preselected account of the authorized user, or other pre-selected payment method.

The loan period of time and the load period time run concurrently and are equal to one another, each being 60 months, 72 months, 84 months, 96 months, 108 months, 120 months, 180 months, 240 months, 300 months, 360 months, etc., in specific examples, and the required installment loads from the card issuer to the prepaid debit card and the required installment repayments from the authorized user to the lender are made each month, on or before a specified day. Again, for simplicity the installment repayments are equal amounts, and the loads are equal amounts, in an illustrative embodiment. It is to be understood that the loan period of time and the load period of time can be any desired period of time, and that the installment repayments and the loads can be made on a monthly basis, a bi-monthly basis, a weekly basis, a quarterly basis, etc., according to the loan terms of the installment loan.

According to the principle of the invention, the amount of each installment load is more than the amount of each installment repayment throughout the term of the prepaid card and the term of the installment loan. The cash value of the prepaid card paid to the authorized user in the form of periodic installment loads to the prepaid card is greater than the sum total of the installment repayments made by the authorized user to the lender, and the sum total of the installment repayments made by the authorized user to the lender is greater than the purchase price of the prepaid card but is less than the cash value of the prepaid card. However, the object of this method is that the card issuer is able to market a prepaid card for sale to customers for a purchase price that is less than, or otherwise discounted from, the cash value of the prepaid card. Because the purchase price of the prepaid card is less than the cash value of the prepaid card, the prepaid card is considered to be a “discounted” prepaid card. This clearly provides the customer with an incentive to purchase the prepaid card, since the face or cash value of the prepaid card is less than the purchase price of the prepaid card and is less than what the authorized user will pay via the installment repayments throughout the term or life of the prepaid card and the term of the installment loan. It is, however, the responsibility of the customer to obtain the installment loan for an amount equal to the “discounted” purchase price of the prepaid card. Once the installment loan is obtained, the lender pays the loaned purchase price to the card issuer, which immediately funds the card issuer with liquid cash that the card issuer may use for any investment purpose whatsoever. Once funded or capitalized according to the principle of the invention, the card issuer gets immediate use of all the money used to fund the prepaid card, with the exception that the card issuer must load the prepaid card each month with an installment load until the conclusion of the term of the prepaid card and the term of the installment loan.

According to the terms of use established by the card issuer, preferably set forth in the loan terms of the installment loan, use of the prepaid card by the authorized user is restricted to payment of the authorized user's obligations, purchases, and monthly bills. The prepaid card is not enabled for obtaining cash, such as from a cash machine, a point-of-purchase register, a bank, etc. Restrictions on the account associated with the prepaid card are built in to restrict use of the prepaid card for obtaining cash. And so because each installment repayment is less than each installment load, the prepaid card method increases the authorized user's monthly income by the difference between the installment load and the installment repayment, which increases the authorized user's monthly income for use of the prepaid card as a payment instrument for the authorized users obligations, purchases, and monthly bills, excluding providing cash to the authorized user that could lead to abuse or irresponsible spending by the authorized user.

As a matter of example, the card issuer sets a cash value of $120,000.00 to the prepaid card for a term of 120 months, and sets a purchase price of $60,000.00 for the prepaid card, which is 50% of the cash value of the prepaid card. The customer obtains the installment loan from the lender for an amount equal to the purchase price of the prepaid card being an amount that is less than the cash value of the card, which, in this example, is 50% of the cash value of the card, or $60,000.00, which the customer is obligated to pay back to the lender in 120 equal monthly installments or installment repayments of $750.00 for a total repayment amount of $90,000.00 under the installment loan. Again, the loan amount and payment terms are agreed upon between the lender and the card issuer and the customer via the loan terms of the installment loan. After the installment loan is approved, the lender pays the loaned amount, the $60,000.00, the purchase price of the prepaid card, to the card issuer, and the card issuer issues the prepaid card to the customer and designates the customer an authorized user of the prepaid card. The card issuer automatically electronically loads the prepaid card with monthly installment loads of $1,000.00 for the 120 month term of the prepaid card until the value of the prepaid card and the term of the card are reached, and the authorized user concurrently makes monthly installment repayments of $750.00 to the lender for the 120 month term of the installment loan. Again, the 120-month term of the installment loan and the 120-month term of the installment loads run concurrently. Once the prepaid card is electronically loaded each month, the authorized user can then use the prepaid card to pay for the authorized user's obligations, purchases, and monthly bills from the installment load, but not cash as the prepaid card is disabled for obtaining cash. Again, the electronic loading is performed by the card issuer's pre-programmed electronic card-loading computer system linked to the account associated with the prepaid card, and the authorized user makes the monthly installment repayments to the lender via check or direct debit or direct withdrawal in which the lender withdraws funds from a preselected account of the authorized user, or other pre-selected payment method.

According to the principle of the invention, the card issuer is funded with $60,000.00 from the lender according to the installment loan between the lender and the authorized user, the card issuer makes $1,000.00 monthly installment loads to the prepaid card for the 120 month term of the prepaid card totaling $120,000.00, the authorized user makes $750.00 monthly installment repayments to the lender for the 120 month term of the prepaid card totaling $90,000.00, the $1,000.00 amount of each installment load is $250.00 more than the amount of each $750.00 installment repayment throughout the term of the prepaid card thereby increasing the monthly income to the authorized user by $250.00 for each month, the authorized user thus realizes a $30,000.00 profit over the 120 month term of the installment loan, and the total $120,000.00 amount loaded onto the prepaid card by the card issuer via the 120 $1,000.00 monthly installment loads to the prepaid card is greater than the $90,000.00 paid back to the lender via the 120 $750.00 installment repayments from the cardholder to the lender, and the total $90,000.00 repayment from the authorized user to the lender is greater than the $60,000.00 prepaid card purchase price paid to the card issuer from the lender. In this method, the card issuer is funded with investment cash that it can use for any investment purpose, the cardholder makes more money from the card issuer than is paid back to the lender, and the lender makes more money than the loan amount but less than the cash value of the card. Because the total of the installment repayments from the authorized user to the lender is less than the cash value of the prepaid card, the prepaid card is considered a “discounted” prepaid card, and the installment repayments from the authorized user to the lender are considered “discounted” payments. Again, the objective of this method is that the card issuer is able to market a prepaid card for sale to customers for a discounted purchase amount that is less than the face value of the prepaid card in order to obtain needed funding via an installment loan between a customer and the lender to cover the purchase price of the prepaid card between the customer and the lender without having to take a loan from a lending bank or institution or having to use its own cash, the customer has an incentive to purchase the prepaid card for less than its cash value, and the monthly income of the authorized user is increased to provide the authorized user with additional monthly funds to pay for the authorized user's obligations, purchases, and monthly bills, with the exception that the prepaid card is not enabled to be used for obtaining cash.

In another example, the card issuer sets a cash value of $97,200.00 to the prepaid card for a term of 108 months, and sets a purchase price of $53,460.00 for the prepaid card, which is 45% of the cash value of the prepaid card. The customer obtains the installment loan from the lender for an amount equal to the purchase price of the prepaid card being an amount that is less than the cash value of the card, which, in this example, is 45% of the cash value of the card, or $53,460.00, which the customer is obligated to pay back to the lender in 108 equal monthly installments or installment repayments of $717.75 for a total repayment amount of $77,517.00 under the installment loan. Again, the loan amount and payment terms are agreed upon between the lender and the card issuer and the customer via the loan terms of the installment loan. After the installment loan is approved, the lender pays the loaned amount, the $53,460.00, the purchase price of the prepaid card, to the card issuer, and the card issuer issues the prepaid card to the customer and designates the customer an authorized user of the prepaid card. The card issuer automatically electronically loads the prepaid card with monthly installment loads of $900.00 for the 108 month term of the prepaid card until the value of the prepaid card and the term of the card are reached, and the authorized user concurrently makes monthly installment repayments of $717.75 to the lender for the 108 month term of the installment loan. Again, the 108-month term of the installment loan and the 108-month term of the installment loads run concurrently. Once the prepaid card is electronically loaded each month, the authorized user can then use the prepaid card to pay for the authorized user's obligations, purchases, and monthly bills from the installment load, but not cash as the prepaid card is disabled for obtaining cash. Again, the electronic loading is performed by the card issuer's pre-programmed electronic card-loading computer system linked to the account associated with the prepaid card, and the authorized user makes the monthly installment repayments to the lender via check or direct debit or direct withdrawal in which the lender withdraws funds from a preselected account of the authorized user, or other pre-selected payment method.

According to the principle of the invention, in the above alternate embodiment of the invention the card issuer is funded with $53,460.00 from the lender according to the installment loan between the lender and the authorized user, the card issuer makes $900.00 monthly installment loads to the prepaid card for the 108 month term of the prepaid card totaling $92,200.00, the authorized user makes $717.75 monthly installment repayments to the lender for the 108 month term of the prepaid card totaling $77,517.00, the $900.00 amount of each installment load is $182.25 more than the amount of each $717.75 installment repayment throughout the term of the prepaid card thereby increasing the monthly income to the authorized user by $182.25.00 for each month, the authorized user thus realizes a $19,683.00 profit over the 108 month term of the installment loan, and the total $97,200.00 amount loaded onto the prepaid card by the card issuer via the 108 $900.00 monthly installment loads to the prepaid card is greater than the $77,517.00 paid back to the lender via the 108 $717.75 installment repayments from the cardholder to the lender, and the total $77,517.00 repayment from the authorized user to the lender is greater than the $53.460.00 prepaid card purchase price paid to the card issuer from the lender. In this method, the card issuer is funded with investment cash that it can use for any investment purpose, the cardholder makes more money from the card issuer than is paid back to the lender, and the lender makes more money than the loan amount but less than the cash value of the card.

The relative amounts of the cash value of the prepaid card, the purchase price of the prepaid card, the installment load amounts, and the installment repayment amounts can be vary depending on the term of the installment loan and the cash value of the prepaid card. In general, the ratio of the cash value to the purchase, and the ratio of the installment loads to the installment payments, increase as the installment loan and installment load periods of time increase, and decrease as the installment loan and installment load periods of time decrease. In an illustrative embodiment, the purchase price for the prepaid card is no more than 50% of the cash value of the prepaid card, and the total amount of the installment loads, which is equal to the purchase price of the prepaid card, is no more than 25% more than the total amount of the installment repayments.

Consistent with the above example, the cash value of the prepaid card, the purchase price of the prepaid card, the term of the prepaid card, the amount and loading schedule of the installment loads, and the amount and repayment schedule of the installment repayments are set forth above simply as a matter of example. Other terms (e.g., 60 months, 72 months, 84 months, 96 months, 180 months, 240 months, 300 months, 360 months) and amounts (e.g., $5,000.00, $10,000.00, $20,000.00, $50,000.000, $100,000.00, $200,000.00, $500,000.00, $1,000,000.00, etc.), including installment load amounts and installment repayment amounts, can be used in the prepaid card system according to this disclosure without departing from the invention. The cash value of the prepaid card can be any cash value set by the card issuer, and the purchase price of the prepaid card can be any set amount discounted from the set cash value of the prepaid card. The purchase price can vary depending on the cash value of the card. For instance, the purchase price can be less for low prepaid card cash values, and can be comparatively increased for higher prepaid card cash values, or vice versa, consistent with the teachings of the invention.

Once the prepaid card is loaded, in the preferred embodiment the authorized user can then use it for the purposes explained above, including by using an assigned PIN to validate payments. This process is much like using a debit card. In alternate embodiments, the prepaid card is a smart card wherein the cash balance is automatically stored in memory or in the prepaid card itself.

In the event of loss or theft, the prepaid card cannot be used without the PIN number. The authorized user will be instructed to keep the PIN number at a secret and secured location. Because the PIN is typically encrypted or encoded, it is difficult to crack. The PIN number is, therefore not readily obtainable by a stranger. In an illustrative embodiment, the PIN for use with the prepaid card of this invention will contain an alphanumeric expression only the authorized user would know. Alphanumeric expressions, even if restricted to only four digits and letters, present a combination many times more difficult to crack than mere numerical symbols. Symbols, such as an asterisk, can also be part of the PIN.

In a particular example, the prepaid card of this invention operates only by use of a PIN. No personal identification information is required for making payments. No signature, other than the numerical PIN signature, is required. A payee is not obliged to accept payment unless the authorized user has sufficient funds in the account of the prepaid card. No more than the designated installment load is loaded onto the card each month, and each installment load is made on the 1^{st} Calendar Day of each Calendar Month according to the Gregorian calendar. In alternate embodiments, the installment loads can be made on another designated Calendar Day of each Calendar month as agreed upon by and between the card issuer and the authorized user pursuant to the terms for the card established between the card issuer and the authorized user. The prepaid card can be encoded or encrypted so it expires after a designated term of the card.

A credit- or debit-type plastic card can comprise a magnetic stripe, RFID device, or electronic chip containing the electronic information. A small electronic device, similar to a mini-calculator, can be provided to display the running account balance. The type of device used will depend on the card issuer's preferences.

A number of types of “cards” are available for use in this method. The cards can be similar in size and configuration to a standard debit or credit card. A bar code system can be used with conventional scanners. The card can be in the form of a key chain, bracelet, ring, or mini-card employing a magnetic strip or bar code, RFID transceiver, or other means for electronically reading information therefrom. Alternatively, the card may not be a card at all, but could be any magnetic or electronic device that can be encoded with stored information, and can be scanned or read. For example, the card can take the form of a credit card-sized calculator able to display one's current available loads. PIN authorization allows the payments to be electronically transferred to designated payee accounts.

In addition to the above-described prepaid card methods, the invention also provides a “debt prepaid card” method to assist indebted customers. In this aspect of the invention, the prepaid card method is as described above. However, in the debt prepaid card method, debt of the customer, whether in whole or in part, is paid off, by the lender in one embodiment, and by the card issuer in another embodiment. In other words, using a portion of the loaned amount of the purchase price of the prepaid card, the lender pays off designated debt owed by the customer/authorized user in one embodiment, and the card issuer pays off designated debt owed by the customer/authorized user in another embodiment. The amount of the debt that is paid off is a portion not only of the cash value of the card, but also a portion of the purchase price for the prepaid card. The installment loads made to the prepaid card by the card issuer are of pre-selected amounts to provide the authorized user with sufficient funds, each month for example, to pay the lender the predetermined installment repayments according to the terms of the installment loan between the lender and the authorized user. In this system, the authorized user takes in more each month via each installment load than each monthly installment repayment required to be paid from the cardholder to the lender. However, designated debt of the authorized user of the prepaid card is paid off, the card issuer is funded via the loan amount equal to the purchase price of the prepaid card less the amount of the debt that is paid off, and the periodic installment loads are less than the periodic installment repayments providing the authorized user with sufficient funds to make the installment repayments to the lender with some funds remaining for the authorized user to use for meeting other obligations of the authorized user.

As a matter of example, the card issuer sets a cash value of $120,000.00 to the prepaid card for a term of 120 months, and sets a purchase price of $60,000.00 for the prepaid card. The customer has debt in the amount of $12,000.00 in this example, and obtains the installment loan from the lender for an amount equal to the purchase price of the prepaid card being an amount that is less than the cash value of the card, which, in this example, is fifty percent of the value of the card, or $60,000.00, which the customer is obligated to pay back to the lender in 120 equal monthly installments or installment repayments of $750.00. Again, the loan amount and payment terms are agreed upon between the lender and the card issuer and the customer.

After the installment loan is approved in one embodiment, from the $60,000.00 loaned amount the lender pays off the $12,000.00 debt, pays the $48,000.00 balance of the loaned amount to the card issuer, and the card issuer issues the prepaid card funded by the $48,000.00 balance of the loaned amount to the customer and designates the customer an authorized user of the prepaid card. The card issuer automatically electronically loads the prepaid card with monthly installment loads of $900.00 for the 120 month term of the prepaid card until the cash value of the prepaid card less the $12,000.00 debt payment by the lender, being a total amount of $108,000.00, is reached and the term of the prepaid card is reached, and the authorized user concurrently makes monthly installment repayments of $750.00 to the lender for the 120 month term of the installment loan in order to pay back $90,000.00 in repayment of loaned amount of the installment loan. After the installment loan is approved in another embodiment, the lender pays the loaned amount, the $60,000.00, the purchase price of the prepaid card, to the card issuer, the card issuer pays off the $12,000.00 debt, and the card issuer issues the prepaid card funded by the $48,000.00 balance of the loaned amount to the customer and designates the customer an authorized user of the prepaid card. The card issuer automatically electronically loads the prepaid card with monthly installment loads of $900.00 for the 120 month term of the prepaid card until the value of the prepaid card, $90,000.00 by the 120 installment loads plus the $12,000.00 amount of the debt paid off by the card issuer, and the term of the card are reached, and the authorized user concurrently makes monthly installment repayments of $750.00 to the lender for the 120 month term of the installment loan in order to pay back $90,000.00 in repayment of loaned amount of the installment loan.

Again, the 120-month term of the installment loan and the 120-month term of the installment loads run concurrently. Once the prepaid card is electronically loaded each month, the authorized user can then use the prepaid card to pay for the authorized user's obligations, purchases, and monthly bills from the installment load, but not cash as the prepaid card is disabled for obtaining cash. Again, the electronic loading is performed by the card issuer's pre-programmed electronic card-loading computer system linked to the account associated with the prepaid card, and the authorized user makes the monthly installment repayments to the lender via check or direct debit or direct withdrawal in which the lender withdraws funds from a preselected account of the authorized user, or other pre-selected payment method.

According to the principle of the invention, after paying off the $12,000.00 debt of the customer/authorized user the card issuer is funded with $48,000.00 from the lender according to the installment loan between the lender and the authorized user, the card issuer makes $900.00 monthly installment loads to the prepaid card for the 120 month term of the prepaid card totaling $108,000.00, the authorized user makes $750.00 monthly installment repayments to the lender for the 120 month term of the prepaid card totaling $90,000.00, the $900.00 amount of each installment load is more than the amount of each $750.00 installment repayment throughout the term of the prepaid card thereby increasing the monthly income to the authorized user by $150.00 for each month, the difference between each installment load and each installment repayment, and the total $108,000.00 amount loaded onto the prepaid card by the card issuer via the 120 $900.00 monthly installment loads to the prepaid card is greater than the $90,000.00 paid back to the lender via the 120 $750.00 installment repayments from the cardholder to the lender, the total $90,000.00 repayment from the authorized user to the lender is greater than the $60,000.00 prepaid card purchase price, and the $12,000.00 debt of the authorized user is paid off. In this method, the card issuer is funded with investment cash that it can use for any investment purpose, the cardholder makes more money from the card issuer than is paid back to the lender, the cardholder's debt is paid off, and the lender makes more money than the installment loan amount but less than the cash value of the card. Because the total of the installment repayments from the authorized user to the lender is less than the cash value of the prepaid card, the prepaid card is considered a “discounted” prepaid card, and the installment repayments from the authorized user to the lender are considered “discounted” payments. Again, the objective of this method is that the card issuer is able to market a prepaid card for sale to customers for a discounted purchase amount that is less than the face value of the prepaid card in order to obtain needed funding via an installment loan between a customer and the lender to cover the purchase price of the prepaid card between the customer and the lender without having to take a loan from a lending bank or institution or having to use its own cash, the customer has an incentive to purchase the prepaid card for less than its cash value while providing debt relief for designated debt of the customer, and the monthly income of the authorized user is increased to provide the authorized user with additional monthly funds to pay for the authorized user's obligations, purchases, and monthly bills, with the exception that the prepaid card is not enabled to be used for obtaining cash.

In “debt prepaid card” methods according to the invention, the relative amounts of the cash value of the prepaid card, the purchase price of the prepaid card, the installment load amounts, and the installment repayment amounts can be vary depending on the term of the installment loan and the cash value of the prepaid card. In general, the ratio of the cash value to the purchase, and the ratio of the installment loads to the installment payments, increase as the installment loan and installment load periods of time increase, and decrease as the installment loan and installment load periods of time decrease. In an illustrative embodiment of a debt prepaid card method, the purchase price for the prepaid card is no more than 50% of the cash value of the prepaid card, the debt amount is no more than 25% of the purchase price of the prepaid card, and the total amount of the installment loads, which is equal to the purchase price of the prepaid card less the debt amount, is no more than 25% more than the total amount of the installment repayments.

According to the above disclosure, in one embodiment a method includes a card issuer providing a prepaid card set to a cash value, loadable to the prepaid card by periodic loads, and a purchase price that is less than the cash value, a customer, having debt less than the cash value of the card, obtaining an installment loan from a lender for an amount equal to the purchase price of the prepaid card and that is repayable to the lender by periodic repayments, the lender paying off the debt with a portion of amount leaving a balance of the amount, and loaning the balance of the amount to the card issuer, the card issuer issuing the prepaid card to the customer and designating the customer an authorized user of the prepaid card, when the card issuer receives the balance of the amount from the lender, the card issuer loading the cash value to the prepaid card by the periodic loads, and the authorized user repaying the installment loan to the lender by the periodic repayments, wherein a total of the repayments is greater than the purchase price of the prepaid card, and is less than the cash value of the prepaid card. The periodic loads are equal, the periodic repayments are equal, and each of the periodic loads is greater than each of the periodic repayments.

According to the above disclosure, in another embodiment a method includes a card issuer providing a prepaid card set to a cash value, loadable to the prepaid card by periodic loads, and a purchase price that is less than the cash value, a customer, having debt less than the cash value of the card, obtaining an installment loan from a lender for an amount equal to the purchase price of the prepaid card and that is repayable to the lender by periodic repayments, the lender paying the amount to the card issuer, the card issuer paying off the debt, issuing the prepaid card to the customer, and designating the customer an authorized user of the prepaid card, when the card issuer receives the amount from the lender, the card issuer loading the cash value to the prepaid card by the periodic loads, and the authorized user repaying the installment loan to the lender by the periodic repayments, wherein a total of the repayments is greater than the purchase price of the prepaid card, and is less than the cash value of the prepaid card. The periodic loads are equal, the periodic repayments are equal, and each of the periodic loads is greater than each of the periodic repayments.

Those having ordinary skill in the art will readily appreciate that exemplary methods for issuing a prepaid card to an authorized user, for funding a card issuer of prepaid cards with capital useful by the card issuer for producing wealth and for funding a prepaid card of an authorized user, for relieving debt of an authorized user of a prepaid card, and for establishing a stream of income for an authorized user of a prepaid card issued by a card issuer are disclosed. The methods are straightforward and easy to implement, and exploit a prepaid card for beneficial purposes not only for the authorized user of the prepaid card, but also the lender, and the card issuer. The authorized user benefits in a number of ways. The authorized user benefits by receiving a stream of income in the form of installment loads to the prepaid card made throughout the term of the load period of time that the authorized user can use to pay for his obligations, purchases, and monthly bills, but not obtain cash because the prepaid card is disabled from obtaining cash, such as from a cash machine, a point-of-purchase register, a bank, etc. Because the prepaid card is disabled from allowing the authorized user to obtain cash, the authorized user is prevented for spending cash unwisely or carelessly and is motived to use the prepaid card to meet his obligations, make purchases, and pay monthly bills. The authorized user also benefits by purchasing a stream of income in the form of installment loads to a prepaid card having a cash value that is more than the purchase price for the prepaid card and that is more than what the authorized user of the prepaid card pays back to the lender. The authorized user also benefits from debt relief according to specific embodiments of the invention. The lender benefits by receiving a total amount of installment repayments that is greater than the loan amount of the purchase price of the prepaid card. Finally, the card issuer benefits by obtaining funding from the lender generated by the installment loan between the lender and the customer that can be used by the card issuer for any investment purpose, such as for high-interest short-term and overnight loans, while also being able to use the funding to fund the prepaid card by the periodic installment loads. The card issuer thus has the opportunity to use the capital to generate profits greater than the purchase price of the prepaid card during the load and loan periods of time, which are the same and that run concurrently. Therefore, the card issuer can market a prepaid card for sale to customers for a discounted purchase amount that is less than the cash or face value of the prepaid card in order to obtain needed funding via an installment loan between a customer and the lender to cover the purchase price of the prepaid card between the customer and the lender without having to take a loan from a lending bank or institution or having to use its own cash.

The present invention is described above with reference to illustrative embodiments. However, those skilled in the art will recognize that changes and modifications may be made in the described embodiments without departing from the nature and scope of the present invention. Various further changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A method, comprising:
a card issuer providing a prepaid card set to a cash value, loadable to the prepaid card by periodic loads, and a purchase price that is less than the cash value;
a customer obtaining an installment loan from a lender for an amount equal to the purchase price of the prepaid card and that is repayable to the lender by periodic repayments;
the lender paying the amount to the card issuer;
the card issuer issuing the prepaid card to the customer and designating the customer an authorized user of the prepaid card, when the card issuer receives the amount from the lender;
the card issuer loading the cash value to the prepaid card by the periodic loads taken from the amount;
the authorized user repaying the installment loan to the lender by the periodic repayments; and
a total amount of the repayments is greater than the purchase price of the prepaid card, and is less than the cash value of the prepaid card.

2. The method according to claim 1, wherein the periodic loads are equal.

3. The method according to claim 1, wherein the periodic repayments are equal.

4. The method according to claim 1, wherein each of the periodic loads is greater than each of the periodic repayments.

5. A method, comprising:
a card issuer providing a prepaid card set to a cash value, loadable to the prepaid card by periodic loads, and a purchase price that is less than the cash value;
a customer, having debt less than the cash value of the card, obtaining an installment loan from a lender for an amount equal to the purchase price of the prepaid card and that is repayable to the lender by periodic repayments;
the lender paying off the debt with a portion of amount leaving a balance of the amount, and loaning the balance of the amount to the card issuer;
the card issuer issuing the prepaid card to the customer and designating the customer an authorized user of the prepaid card, when the card issuer receives the balance of the amount from the lender;
the card issuer loading the cash value to the prepaid card by the periodic loads taken from the amount;
the authorized user repaying the installment loan to the lender by the periodic repayments; and
a total of the repayments is greater than the purchase price of the prepaid card, and is less than the cash value of the prepaid card.

6. The method according to claim 5, wherein the periodic loads are equal.

7. The method according to claim 5, wherein the periodic repayments are equal.

8. The method according to claim 5, wherein each of the periodic loads is greater than each of the periodic repayments.

9. A method, comprising:
a card issuer providing a prepaid card set to a cash value, loadable to the prepaid card by periodic loads, and a purchase price that is less than the cash value;
a customer, having debt less than the cash value of the card, obtaining an installment loan from a lender for an amount equal to the purchase price of the prepaid card and that is repayable to the lender by periodic repayments;
the lender paying the amount to the card issuer;
the card issuer paying off the debt, issuing the prepaid card to the customer, and designating the customer an authorized user of the prepaid card, when the card issuer receives the amount from the lender;
the card issuer loading the cash value to the prepaid card by the periodic loads taken from the amount;
the authorized user repaying the installment loan to the lender by the periodic repayments; and
a total of the repayments is greater than the purchase price of the prepaid card, and is less than the cash value of the prepaid card.

10. The method according to claim 9, wherein the periodic loads are equal.

11. The method according to claim 9, wherein the periodic repayments are equal.

12. The method according to claim 9, wherein each of the periodic loads is greater than each of the periodic repayments.
